(19) United States
(12) Patent Application Publication
(10) Pub. No.: US 2025/0337492 A1
(43) Pub. Date: Oct. 30, 2025

(54) ROUTE SELECTION APPARATUS, ROUTE SELECTION METHOD, AND COMPUTER-READABLE MEDIUM

(71) Applicant: NEC Corporation, Tokyo (JP)

(72) Inventor: Tatsunori OMIYA, Tokyo (JP)

(73) Assignee: NEC Corporation, Tokyo (JP)

(21) Appl. No.: 19/098,107

(22) Filed: Apr. 2, 2025

(30) Foreign Application Priority Data
Apr. 26, 2024 (JP) 2024-072315

(51) Int. Cl. H04B 10/2507

(52) U.S. Cl. CPC H04B 10/2507

(57) ABSTRACT

A route selection apparatus according to an aspect includes one or more memories that store an instruction and one or more processors that execute the instruction. The one or more processors execute the instruction to calculate, for each of a plurality of signal paths connected to a transmission apparatus, distortion generated in a transmission signal output from the transmission apparatus by using information regarding distortion in the signal path, and select one signal path from the plurality of signal paths based on the calculated distortion.

### INCORPORATION BY REFERENCE

This application is based upon and claims the benefit of priority from Japanese patent application No. 2024-072315, filed on Apr. 26, 2024, the disclosure of which is incorporated herein in its entirety by reference.

### TECHNICAL FIELD

The present disclosure relates to a route selection apparatus, a route selection method, and a program.

### BACKGROUND ART

Technologies for achieving efficient and high-quality communication are being studied.

For example, International Patent Publication No. WO2023/105669 discloses an all-photonics network including a photonic node apparatus that performs wavelength conversion by an optical-analog-optical (OAO) wavelength conversion scheme. In this network, each node monitors the signal quality of the path and performs analog compensation on the basis of the monitoring result, thereby suppressing deterioration of the signal quality in the path.

### SUMMARY

As described in International Patent Publication No. WO2023/105669, signal compensation is performed to suppress deterioration of signal quality. As a signal compensation scheme, for example, the following two methods can be considered.

(i) A wavelength converter executes compensation using a digital or analog circuit

(ii) A signal transmission apparatus imparts inverse characteristics of a wavelength converter on a signal transmission path to a transmission signal (i.e., performs pre-equalization).

However, in the method (i), since a compensation circuit is required for each wavelength converter, it is considered that the cost of the communication system increases. In addition, in the method of (ii), in a case where the transmission path is changed, the characteristics of the wavelength converter change as the wavelength converter on the transmission path changes. Therefore, it is necessary to change the method of pre-equalization executed by the transmission apparatus, and it is difficult to set unique pre-equalization. In this way, it is assumed that another problem occurs by compensating for the signal.

One example of an object to be achieved by the example embodiments of the present disclosure is to provide a route selection apparatus, a route selection method, and a program capable of suppressing compensation executed on a transmission signal. Note that the object is merely one example of a plurality of objects to be achieved by a plurality of example embodiments disclosed herein. Other objects or problems and novel features will be apparent from the description of the present specification or the accompanying drawings.

In a first aspect of the present disclosure, a route selection apparatus includes
one or more memories configured to store an instruction, and
one or more processors configured to execute the instruction,
wherein the one or more processors execute the instruction to
calculate, for each of a plurality of signal paths connected to a transmission apparatus, distortion generated in a transmission signal output from the transmission apparatus by using information regarding distortion in the signal path, and
select one signal path from the plurality of signal paths based on the calculated distortion.

In a second aspect of the present disclosure, a route selection method is a method executed by a computer, the method including
calculating, for each of a plurality of signal paths connected to a transmission apparatus, distortion generated in a transmission signal output from the transmission apparatus by using information regarding distortion in the signal path, and
selecting one signal path from the plurality of signal paths based on the calculated distortion.

In a third aspect of the present disclosure, a program causes a computer to execute
calculating, for each of a plurality of signal paths connected to a transmission apparatus, distortion generated in a transmission signal output from the transmission apparatus by using information regarding distortion in the signal path, and
selecting one signal path from the plurality of signal paths based on the calculated distortion.

One example of an effect of the present disclosure is to provide a route selection apparatus, a route selection method, and a program capable of suppressing compensation executed on a transmission signal.

### BRIEF DESCRIPTION OF DRAWINGS

The above and other aspects, features and advantages of the present disclosure will become more apparent from the following description of certain exemplary embodiments when taken in conjunction with the accompanying drawings, in which:

FIG. 1 is a block diagram illustrating an example of a route selection apparatus according to the present disclosure;

FIG. 2 is a flowchart illustrating an example of representative processing of the route selection apparatus;

FIG. 3 is a schematic diagram illustrating an example of a photonic network system according to the present disclosure;

FIG. 4 is a block diagram illustrating an example of a node according to the present disclosure;

FIG. 5 is a block diagram illustrating an example of a management apparatus according to the present disclosure;

FIG. 6 is a flowchart illustrating an example of representative processing of a management apparatus;

FIG. 7A is a flowchart illustrating another example of processing of the management apparatus;

FIG. 7B is a flowchart illustrating another example of processing of the management apparatus; and

FIG. 8 is a block diagram illustrating a hardware configuration example of an information processing apparatus in which processing of a system or an apparatus is executed.

### EMBODIMENTS

Hereinafter, an example embodiment of the present disclosure will be described with reference to the drawings. Note that the following description and drawings in the example embodiment are omitted and simplified as appropriate for clarity of description. Further, in the present disclosure, unless otherwise specified, in a case where “at least one of a plurality of items” is defined for a plurality of items, the definition may mean any one item or may mean any two or more items including all items.

Each of the drawings or figures is merely an example to illustrate one or more example embodiments. Each figure may not be associated with only one particular example embodiment, but may be associated with one or more other example embodiments. As those of ordinary skill in the art will understand, various features or steps described with reference to any one of the figures can be combined with features or steps illustrated in one or more other figures, for example to produce example embodiments that are not explicitly illustrated or described. Not all of the features or steps illustrated in any one of the figures to describe an example embodiment are necessarily essential, and some features or steps may be omitted. The order of the steps described in any of the figures may be changed as appropriate.

### First Example Embodiment

### [Description of Configuration]

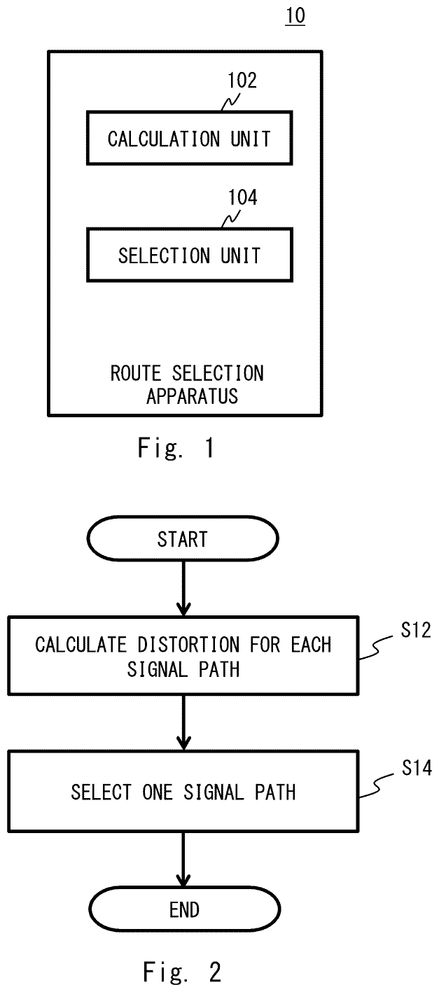

FIG. 1 is a block diagram illustrating an example of a route selection apparatus according to the present disclosure. A route selection apparatus 10 includes a calculation unit 102 and a selection unit 104. Each unit of the route selection apparatus 10 will be described below.

For each of a plurality of signal paths connected to a transmission apparatus that transmits a signal, the calculation unit 102 calculates distortion generated in a transmission signal output from the transmission apparatus by using information regarding distortion in each signal path. Distortion indicates a change from an original signal waveform, such as, a deterioration in frequency characteristics of the signal.

Here, the signal transmitted by the transmission apparatus is an arbitrary digital or analog signal. A signal path connecting a transmission apparatus and a reception apparatus includes, for example, at least transmission paths and one or more relay apparatuses provided between transmission paths as components. A relay apparatus has a function of transferring a signal received from one transmission path to the other transmission path. A relay apparatus may be a node having any of the following functions, but the function of the relay apparatus is not limited thereto.
A function of amplifying a signal received from one transmission path and transmitting the signal to the other transmission path
A function of converting a wavelength or a frequency of a signal received from one transmission path and transmitting the converted signal to the other transmission path
A function of executing digital-to-analog (D/A) conversion or A/D conversion on a signal received from one transmission path and transmitting the converted signal to the other transmission path

Here, it is assumed that there is a plurality of signal paths as signal paths connecting the transmission apparatus and the reception apparatus. That is, in each signal path, at least some of the components (relay apparatus or transmission path) are different from other signal paths. At this time, a transmission signal passes through the signal path, distortion derived from components of the signal path is generated in the transmission signal. Therefore, if the calculation unit 102 calculates the distortion generated in the transmission signal for each signal path, the distortion generated in the transmission signal is considered to be different for each signal path.

The calculation unit 102 may calculate the distortion by using, for example, an index indicating the degree of distortion for each component of the signal path as information regarding the distortion in each signal path. Any index can be used as long as the index indicates the magnitude of distortion by its magnitude. The distortion information used by the calculation unit 102 is stored in either the route selection apparatus 10 or an external apparatus. The distortion information may be updated as appropriate.

The selection unit 104 selects one signal path from the plurality of signal paths on the basis of the distortion calculated by the calculation unit 102. As an example, the selection unit 104 may select a signal path having the minimum distortion calculated by the calculation unit 102 among the plurality of signal paths. Note, however, that the signal path selected by the selection unit 104 is not limited thereto. The selected signal path can be used as a path for the transmission apparatus to actually transmit a signal to the reception apparatus.

In addition, the route selection apparatus 10 may cause the transmission apparatus to execute processing of compensating for all or a part of the distortion of the selected signal path in order to suppress the distortion generated in the signal path selected by the selection unit 104. For example, the route selection apparatus 10 can cause the transmission apparatus to execute processing of canceling all or a part of the distortion derived from components in the selected signal path by using information regarding the distortion in the signal path.

### [Description of Flow]

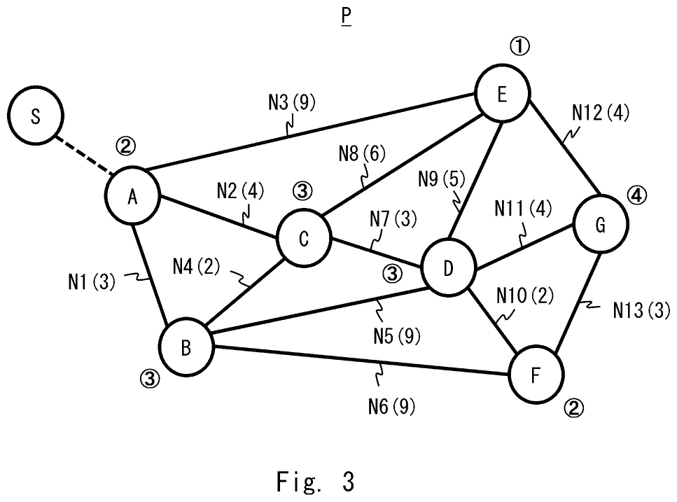

FIG. 2 is a flowchart illustrating an example of representative processing of the route selection apparatus 10. Processing of the route selection apparatus 10 will be described with this flowchart. Note that since details of each processing are as described above, description thereof is omitted as appropriate.

First, for each of the plurality of signal paths, the calculation unit 102 calculates distortion generated in a transmission signal output from the transmission apparatus by using information regarding distortion in the signal path (step S12). The selection unit 104 selects one signal path from the plurality of signal paths on the basis of the distortion calculated by the calculation unit 102 (step S14).

### Description of Advantageous Effects

As described above, the route selection apparatus 10 calculates distortion generated in the signal path for each signal path, and selects one signal path from the plurality of signal paths on the basis of the calculation result. As a result, the route selection apparatus 10 can select a signal path in consideration of the distortion (e.g., select signal path with less distortion), and thus, it is possible to suppress the compensation executed on the transmission signal. That is, if the signal path selected by the route selection apparatus 10 is used for communication, it is not necessary to execute compensation on the transmission signal, or the degree of compensation to be executed on the transmission signal can be suppressed as compared with a case where one signal path is randomly selected and used.

Furthermore, the selection unit 104 may select a signal path that minimizes distortion generated in a transmission signal among the plurality of signal paths as a result of calculation of the calculation unit 102. As a result, the route selection apparatus 10 can further suppress the compensation executed on a transmission signal.

Note that the route selection apparatus 10 may be configured as a single computer apparatus or may be configured as a distributed system including a plurality of computer apparatuses. In the distributed system, processing executed by the route selection apparatus 10 can be shared and executed by a plurality of computer apparatuses. That is, the calculation unit 102 and the selection unit 104 may be distributed and mounted on a plurality of computer apparatuses.

Some or all of the units of the route selection apparatus 10 may be provided in a cloud server constructed on a cloud, or may be provided in another type of virtualization server generated using virtualization technology or the like. Functions other than the functions provided in the server such as a cloud server or a virtualization server are provided in an edge device.

In the following example embodiments, specific examples of the route selection apparatus 10 described in the first example embodiment are disclosed. Note, however, that specific examples of the route selection apparatus 10 illustrated in the first example embodiment are not limited to those described below. In addition, configurations and processing described below are examples, and the present disclosure is not limited thereto.

### Second Example Embodiment

### (2A)

### Description of Configuration

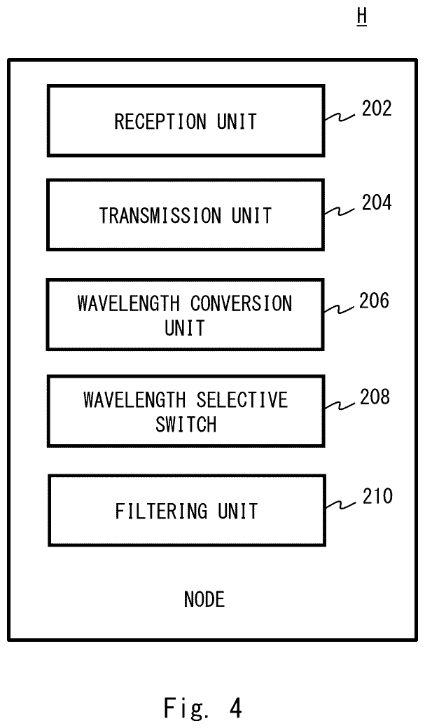

FIG. 3 is a schematic diagram illustrating an example of a photonic network system according to the present disclosure. A photonic network system P includes nodes A to G and transmission paths N1 to N13 for transmitting optical signals (hereinafter also simply referred to as signals), and a management apparatus S. Here, the transmission path N1 connects the nodes A and B, the transmission path N2 connects the nodes A and C, and the transmission path N3 connects the nodes A and E. The transmission path N4 connects the nodes B and C, the transmission path N5 connects the nodes B and D, and the transmission path N6 connects the nodes B and F. The transmission path N7 connects the nodes C and D, the transmission path N8 connects the nodes C and E, and the transmission path N9 connects the nodes D and E. The transmission path N10 connects the nodes D and F, the transmission path N11 connects the nodes D and G, the transmission path N12 connects the nodes E and G, and the transmission path N13 connects the nodes F and G.

Furthermore, FIG. 3 illustrates an index of distortion generated by transmission in each of the transmission paths N1 to N13 and an index of distortion generated if signal wavelength conversion is executed in each of the nodes A to G. Distortion indices of 3, 4, 9, 2, 9, 9, 3, 6, 5, 2, 4, 4, and 3 are defined in the transmission paths N1 to N13, respectively. The distortion index of the transmission path is determined by, for example, the distance of the transmission path, the communication band, and the like. In addition, in a case where signal wavelength conversion is executed in each of the nodes A to G, distortion indices of 2, 3, 3, 3, 1, 2, and 4 are defined, respectively. The distortion index of the node is determined by, for example, the band or frequency characteristics of each node. The larger the distortion index, the larger the degree of distortion generated in the transmission path or the node.

The photonic network system P may be a system capable of simultaneously transmitting optical signals of a plurality of different wavelengths, such as a wavelength division multiplexing (WDM) photonic network system. In the photonic network system P, it is possible to flexibly switch the signal path of an optical signal according to traffic conditions and the like.

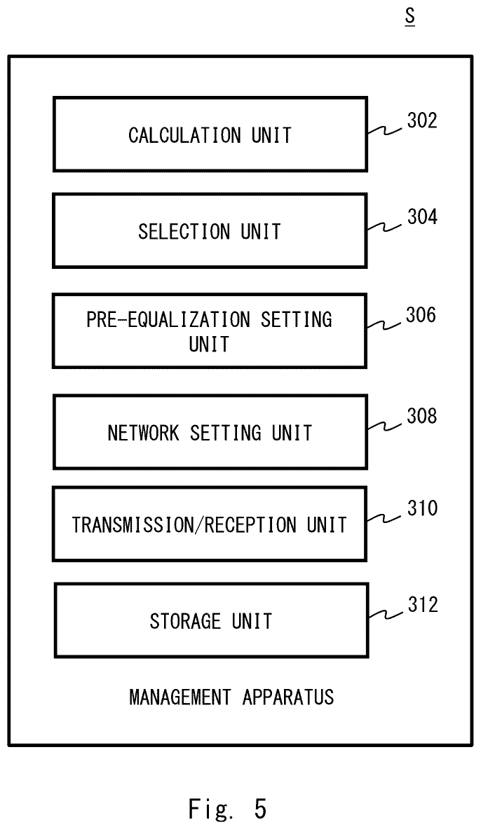

FIG. 4 is a block diagram illustrating an example of a node. A node His a generic term for the nodes A to G in FIG. 3. The node H includes a reception unit 202, a transmission unit 204, a wavelength conversion unit 206, a wavelength selective switch 208, and a filtering unit 210. Each node may be, for example, a reconfigurable optical add/drop multiplexer (ROADM). Each element of the node H will be described below.

The reception unit 202 is an interface that receives a signal from another node or the like, and the transmission unit 204 is an interface that transmits a signal to another node. The node H can transfer the received signal to another node using the reception unit 202 and the transmission unit 204.

If an event such as a wavelength collision described later occurs in a transmission path connected to the node H, the wavelength selective switch 208 extracts a wavelength signal that requires wavelength conversion from the signal received by the reception unit 202 and sends the wavelength signal to the wavelength conversion unit 206. The wavelength conversion unit 206 performs wavelength conversion on the signal. The wavelength-converted signal is sent to the wavelength selective switch 208. The wavelength selective switch 208 multiplexes the wavelength-converted signal with another wavelength multiplexed signal, and then causes the transmission unit 204 to transmit the multiplexed signal.

The node H executes signal wavelength conversion using an OAO wavelength conversion scheme. In this scheme, the node H does not have a digital or analog circuit for signal distortion compensation. Therefore, the node H executes wavelength conversion and distorts the signal. The distortion to the signal waveform generated in wavelength conversion depends on the frequency characteristics of the wavelength conversion unit 206 of the node. Therefore, the distortion index determined for the wavelength conversion of the node may vary depending on the node.

If there is a plurality of nodes H in the signal path and a plurality of wavelength conversions is executed at each node H, distortion is accumulated in the signal. Also, distortion is accumulated in the signal as the signal passes through the transmission path. Therefore, the characteristics of the signal deteriorate as the signal is transmitted. There is also a possibility that communication may become impossible due to deterioration of characteristics in some cases. The management apparatus S of the present disclosure can solve this problem.

The filtering unit 210 executes digital filter processing on a signal transmitted from the node H. As described later, the filtering unit 210 can execute pre-equalization on the transmitted signal according to control of the management apparatus S or the like.

Note that the node H may further have functions such as signal amplification and D/A or A/D conversion as necessary.

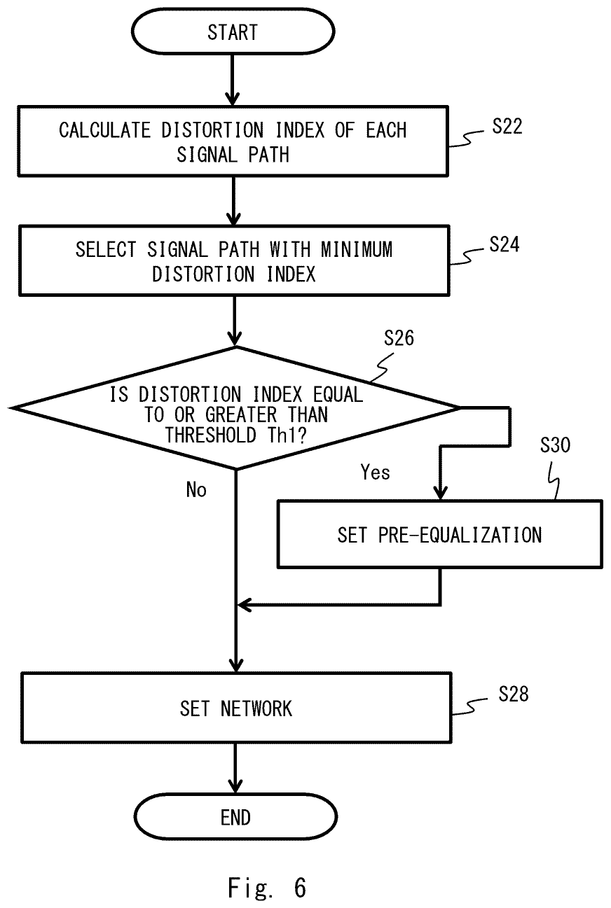

FIG. 5 is a block diagram illustrating an example of the management apparatus S. The management apparatus S includes a calculation unit 302, a selection unit 304, a pre-equalization setting unit 306, a network setting unit 308, a transmission/reception unit 310, and a storage unit 312. The management apparatus S selects which signal path should be used for transmission if a signal is transmitted from one of the nodes illustrated in FIG. 3 to another node. Each element of the management apparatus S will be described below.

The calculation unit 302 calculates distortion generated in a transmission signal output from the transmission apparatus for each of a plurality of signal paths connecting a node that is the transmission apparatus and a node that is the reception apparatus. The signal path to be the calculation target of the calculation unit 302 may be all signal paths connecting the transmission apparatus and the reception apparatus, or may be some signal paths connecting the transmission apparatus and the reception apparatus.

The calculation unit 302 uses information regarding distortion of the photonic network system P stored in the storage unit 312 to calculate distortion. Information regarding distortion of the photonic network system P includes information regarding an index of distortion generated in each of the transmission paths N1 to N13 and an index of distortion generated if signal wavelength conversion is executed in each of the nodes A to G as illustrated in FIG. 3. The storage unit 312 stores this information regarding distortion measured in advance.

In the following example, a calculation example will be described on the assumption that the node A is the signal transmission apparatus and the node G is the signal reception apparatus, but similar calculation is also possible in a case where the transmission apparatus and the reception apparatus are other nodes.

(A) First, it is assumed that there is no signal wavelength collision in the photonic network system P. In this case, nodes on the signal path do not need to execute wavelength conversion. Therefore, the distortion index of each signal path is determined by the distortion index of the transmission path on the signal path. In this example, the following four paths are defined as calculation target signal paths.
(1) Reaching node G from node A via node E
(2) Reaching node G from node A via nodes C and D
(3) Reaching node G from node A via nodes C and E
(4) Reaching node G from node A via nodes B and F

The calculation unit 302 calculates that the distortion indices of (1) to (4) are 13, 11, 14, and 15, respectively, using the distortion information stored in the storage unit 312.

(B) Next, it is assumed that a signal wavelength collision occurs at the transmission path N7 of the photonic network system P. In this case, if a signal path passing through the transmission path N7 is used, the node C needs to execute wavelength conversion. Among the signal paths (1) to (4), distortion associated with the wavelength conversion is further generated in (2). The calculation unit 302 calculates that the distortion indices of (1) to (4) are 13, 14, 14, and 15, respectively, using the distortion information stored in the storage unit 312.

The selection unit 304 selects a signal path having the minimum distortion index from the plurality of calculation target signal paths on the basis of the result calculated by the calculation unit 302. For example, in the case of (A), the selection unit 304 selects (2) having the minimum distortion index. Meanwhile, in the case of (B), the selection unit 304 selects (1) having the minimum distortion index. In this manner, the selection unit 304 selects a signal path used for communication.

Furthermore, the selection unit 304 determines whether or not the distortion index calculated for the signal path selected by the selection unit 304 is equal to or greater than a predetermined threshold Th1. The threshold Th1 is information set in advance and stored in the storage unit 312. This threshold indicates the amount of distortion allowed in signal transmission.

If the distortion index is equal to or greater than the threshold Th1, that is, if it is considered that distortion in the selected signal path is large, the selection unit 304 determines that compensation (specifically, pre-equalization) is necessary at the node A. On the other hand, if the distortion index is less than the threshold Th1, that is, if it is considered that distortion in the selected signal path is small, the selection unit 304 determines that compensation is unnecessary at the node A.

If the selection unit 304 determines that compensation is necessary at the node A, the pre-equalization setting unit 306 sets the node A such that pre-equalization is executed at the node A. Specifically, the pre-equalization setting unit 306 sets pre-equalization to the signal transmitted from the node A by using the transfer function of the frequency characteristics of the node A acquired in advance and stored in the storage unit 312.

For example, assume that (2) is selected as the signal path, and wavelength conversion is performed at each of the node C and the node D. Here, assuming that the transfer functions of the frequency (ω) characteristics at the node C and the node D are G_{C}(ω) and G_{D}(ω), respectively, the pre-equalization setting unit 306 sets the transfer function of the entire path (2) as G_{ALL}(ω). Note that

$${G}_{A L L} ( ω ) = {G}_{C} ( ω ) \cdot {G}_{D} ( ω )$$

The pre-equalization setting unit 306 generates an instruction for giving 1/G_{ALL}(ω), which is a transfer function, to a signal to be transmitted, and outputs the instruction to the node A via the transmission/reception unit 310. In response to receiving the instruction via the reception unit 202, the node A controls the filtering unit 210 to apply the instructed transfer function to the transmission signal. As a result, even in a case where wavelength conversion is performed at the node C and the node D in (2), if the signal reaches the node G, the influence of distortion due to wavelength conversion is suppressed in the signal.

The network setting unit 308 sets the photonic network system P such that communication is performed by the signal path selected by the selection unit 304.

The transmission/reception unit 310 transmits and receives data to and from each node or the like in the photonic network system P. For example, the transmission/reception unit 310 executes transmission and reception with each node for data such as the transfer function determined by the pre-equalization setting unit 306 and the setting of the photonic network system P set by the network setting unit 308. Furthermore, the transmission/reception unit 310 may receive information regarding distortion of the photonic network system P from another apparatus.

The storage unit 312 stores information regarding distortion of the photonic network system P, a distortion calculation method of the calculation unit 302, the transfer function of frequency characteristics of each node, and the like.

### [Description of Flow]

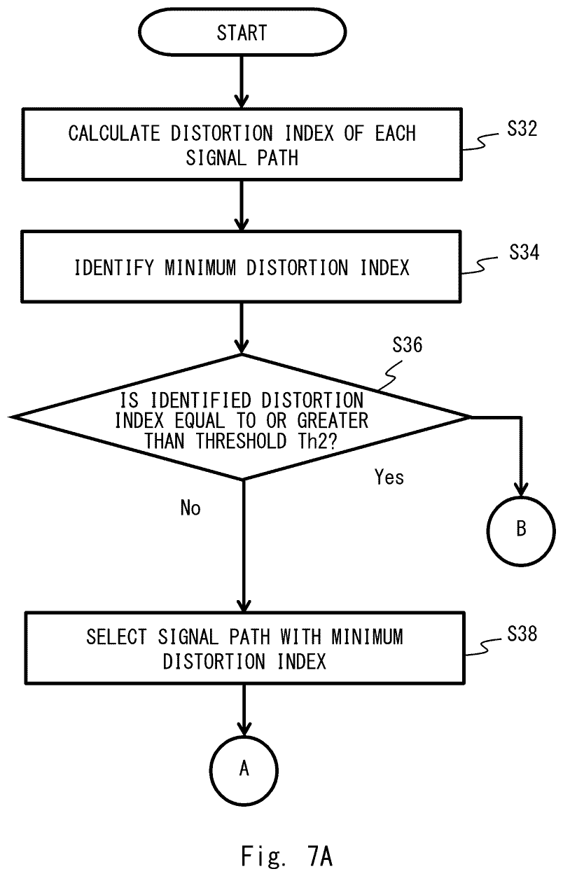

FIG. 6 is a flowchart illustrating an example of representative processing of the management apparatus S. Processing of the management apparatus S will be described with this flowchart. Note that since details of each processing are as described above, description thereof is omitted as appropriate.

First, the calculation unit 302 calculates a distortion index generated in a transmission signal output from the transmission apparatus for each of a plurality of signal paths connecting the transmission apparatus and the reception apparatus (step S22). Then, the selection unit 304 selects a signal path having the minimum distortion index on the basis of the result calculated by the calculation unit 302 (step S24). The selection unit 304 determines whether or not the identified distortion index is equal to or greater than the threshold Th1 (step S26).

If the distortion index is less than the threshold Th1 (No in step S26), the selection unit 304 determines that pre-equalization in the transmission apparatus is unnecessary. In this case, no pre-equalization to the transmission apparatus is set. The network setting unit 308 sets the photonic network system P such that communication is performed by the signal path selected in step S24 (step S28).

On the other hand, if the distortion index is equal to or greater than the threshold Th1 (Yes in step S26), the selection unit 304 determines that pre-equalization in the transmission apparatus is necessary. In this case, the pre-equalization setting unit 306 sets pre-equalization of the transmission apparatus such that pre-equalization in the transmission apparatus is executed (step S30). Thereafter, the network setting unit 308 executes the processing of step S28.

Note that either the processing in steps S26 and S30 or the processing in step S28 may be executed first, or both processing may be executed in parallel.

As a modified example, the management apparatus S may omit the processing of steps S26 and S30. That is, the management apparatus S may omit setting of pre-equalization for the signal path selected by the selection unit 304. However, since pre-equalization is performed as necessary by executing the processing of steps S26 and S30, the quality of the transmission signal can be improved.

In addition, the management apparatus S may omit the processing of step S26 and execute the pre-equalization setting illustrated in step S30 regardless of the value of the distortion index of the selected signal path. However, by executing the processing of step S26 and setting the pre-equalization if the distortion index is large, the management apparatus S can suppress execution of compensation processing if the necessity is low.

### Description of Advantageous Effects

As described above, the management apparatus S selects a signal path in which distortion generated in a transmission signal is minimized among a plurality of signal paths. As a result, the management apparatus S can suppress compensation for the transmission signal. Furthermore, the management apparatus S can set unique pre-equalization for the transmission apparatus by selecting the signal path. Since it is not necessary to provide a circuit for compensation for each node of the photonic network system P, the cost of system construction can be reduced.

Furthermore, the pre-equalization setting unit 306 causes the transmission apparatus to execute processing of compensating for distortion of the selected signal path. As a result, the management apparatus S can improve the quality of the transmission signal. In particular, the pre-equalization setting unit 306 can cause the transmission apparatus to execute the compensation by a simple method by causing the transmission apparatus to execute pre-equalization. However, the distortion compensation processing that can be executed by the transmission apparatus is not limited to pre-equalization.

Furthermore, the pre-equalization setting unit 306 may cause the transmission apparatus to execute processing of compensating for distortion if the distortion index of the selected signal path is equal to or greater than the predetermined threshold Th1. As a result, the management apparatus S can improve the quality of the transmission signal if the necessity of compensation processing is high, and can suppress execution of the compensation processing if the necessity of the compensation processing is low.

Furthermore, the calculation unit 302 may calculate distortion generated in the transmission signal on the basis of distortion derived from the transmission path and distortion derived from wavelength conversion for each of the plurality of signal paths. As a result, the management apparatus S can accurately calculate the distortion of the signal path.

Note that in the above example, the calculation unit 302 calculates the distortion index generated in the transmission signal by simply adding together the distortion indices of the components on the signal path. However, the calculation unit 302 may execute arbitrary weighting on the distortion indices of the components on the signal path according to traffic conditions and the like. The calculation unit 302 can calculate the distortion index generated in the transmission signal in the signal path by adding together the weighted distortion indices.

### (2B)

Hereinafter, an example of a variation of the processing of the management apparatus S illustrated in (2A) will be described. Hereinafter, description of the points already described in (2A) will be omitted as appropriate, and processing specific to (2B) will be mainly described.

In (2A), the management apparatus S selects a signal path having the minimum distortion index calculated in step S22 in FIG. 6 as the path used for communication. However, the path selected by the management apparatus S as the path used for communication is not limited to the signal path having the minimum distortion index calculated in step S22 of FIG. 6.

Specifically, the calculation unit 302 calculates the distortion index for a plurality of signal paths, identifies the signal path having the minimum distortion index, and determines whether or not the identified distortion index is equal to or greater than a predetermined threshold Th2. The threshold Th2 may be the same value as or a different value from the threshold Th1.

If the identified distortion index is less than the predetermined threshold Th2, the selection unit 304 selects a signal path related to the identified distortion index as the signal path used for communication.

If the identified distortion index is equal to or greater than the predetermined threshold Th2, the calculation unit 302 further executes the following calculation. The calculation unit 302 calculates, for each of the plurality of signal paths for which a distortion index is to be calculated, a distortion index of a signal path in a case where pre-equalization is performed by the transmission apparatus. Then, the selection unit 304 selects a signal path having the minimum distortion index in a case where pre-equalization is performed as the path used for signal transmission.

Note that the signal paths for which the distortion index is calculated in a case where pre-equalization is performed by the transmission apparatus may be all the signal paths for which the distortion index is first calculated, or some of all the signal paths for which the distortion index is first calculated. Some signal paths are, for example, signal paths in which the calculated distortion index is equal to or less than a predetermined threshold Th3.

As described above, after the selection unit 304 selects the signal path used for communication, the necessity of pre-equalization may be determined according to the magnitude of the distortion index of the selected signal path. Alternatively, pre-equalization may be performed or omitted regardless of the distortion index of the selected signal path. The description about this point is as given in (2A).

Hereinafter, a situation (B) in (2A) will be described as an example. If a signal wavelength collision occurs at the transmission path N7 of the photonic network system P, the calculation unit 302 calculates that the distortion indices of (1) to (4) are 13, 14, 14, and 15, respectively. Here, the calculation unit 302 determines whether or not the minimum distortion index 13 is equal to or greater than the threshold Th2.

If the threshold Th2 exceeds 13, the selection unit 304 selects (1) corresponding to the distortion index 13 as the signal path used for communication. On the other hand, if the threshold Th2 is 13 or less, the calculation unit 302 calculates a distortion index of a signal path in a case where pre-equalization is performed by the node A for each of (1) to (4) by using information regarding distortion of the photonic network system P. In this recalculation, it is assumed that all distortions derived from wavelength conversion performed at the node C are eliminated by performing pre-equalization. As a result of the recalculation, the calculation unit 302 calculates that the distortion indices of (1) to (4) are 13, 11, 14, and 15, respectively.

Note that in the above recalculation, the distortion index subtracted by pre-equalization from the distortion index indicated by the initial calculation result is not limited to the same value as the distortion index in the wavelength conversion of the node, and may be a part of the distortion index in the wavelength conversion of the node. Furthermore, even in a case where distortion derived from wavelength conversion is generated in a signal path other than (2), the calculation unit 302 can recalculate the distortion index of the signal path in the same manner as in (2).

The selection unit 304 selects (2) corresponding to the distortion index 11 that is the minimum as a result of recalculation as the signal path used for communication. Then, the network setting unit 308 sets the photonic network system P such that communication is performed by the signal path selected by the selection unit 304.

### [Description of Flow]

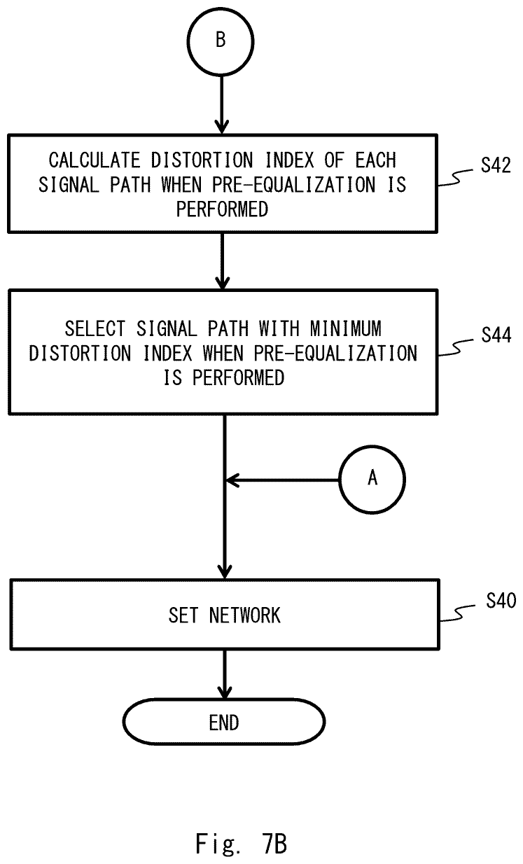

FIGS. 7A and 7B are flowcharts illustrating an example of representative processing of the management apparatus S. Processing of the management apparatus S will be described with this flowchart. Note that since details of each processing are as described above, description thereof is omitted as appropriate.

First, the calculation unit 302 calculates a distortion index generated in the transmission signal (step S32). This description is similar to step S22 in FIG. 6. Then, the calculation unit 302 identifies the minimum distortion index of the distortion indices calculated in step S32 (step S34). The calculation unit 302 determines whether or not the identified distortion index is equal to or greater than the threshold Th2 (step S36).

If the identified distortion index is less than the threshold Th2 (No in step S36), the selection unit 304 selects a signal path related to the distortion index identified in step S34 as the signal path used for communication (step S38). The network setting unit 308 sets the photonic network system P such that communication is performed by the signal path selected in step S38 (step S40).

If the identified distortion index is equal to or greater than the threshold Th2 (Yes in step S36), the calculation unit 302 calculates a distortion index of a signal path in a case where pre-equalization is performed by the transmission apparatus for each of the plurality of signal paths for which calculation is performed in step S32 (step S42). Then, the selection unit 304 selects a signal path having the minimum distortion index in a case where pre-equalization is performed as the path used for signal transmission (step S44). The network setting unit 308 executes the processing described in step S40.

Note that the management apparatus S may execute the processing of step S26 and subsequent steps illustrated in FIG. 6 after at least one of the processing of step S38 or S44. In this case, the threshold Th2 may be set to a value larger than the threshold Th1.

### Description of Advantageous Effects

As described above, the selection unit 304 selects a signal path having the minimum distortion among signal path distortions that occur in a case where the transmission apparatus executes processing of compensating for signal path distortion (e.g., pre-equalization). As a result, the management apparatus S can select a signal path with less distortion, and the signal quality can be improved.

Furthermore, if the minimum distortion index among the signal path distortions that occur in a case where the distortion compensation processing is not executed is equal to or greater than the threshold Th2, the calculation unit 302 may calculate, for each signal path, the signal path distortion that occurs in a case where the distortion compensation processing is executed. The selection unit 304 selects a signal path on the basis of the calculation result. As a result, the management apparatus S can improve the quality of the transmission signal if the necessity of compensation processing is high, and can suppress execution of the compensation processing if the necessity of the compensation processing is low.

Note that, similarly to the route selection apparatus 10, the management apparatus S may be configured as a single computer apparatus or may be configured as a distributed system including a plurality of computer apparatuses.

In the example embodiments described above, the present disclosure has been described as a hardware configuration, but the present disclosure is not limited thereto. In the present disclosure, the processing of the apparatus configuring the route selection apparatus 10 or management apparatus S described in the above example embodiments can also be implemented by causing a processor in a computer to execute a computer program.

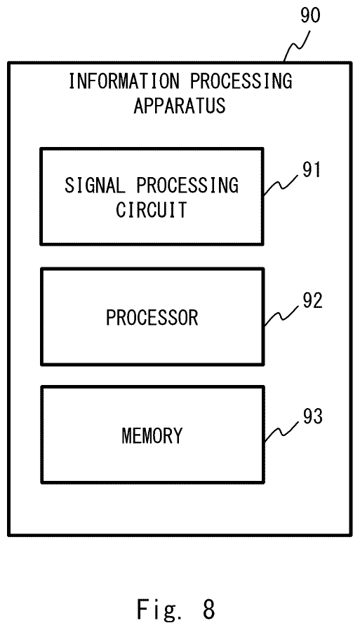

FIG. 8 is a block diagram illustrating a hardware configuration example of an information processing apparatus (i.e., computer) in which processing of the system or apparatus illustrated in each example embodiment is executed. Referring to FIG. 8, an information processing apparatus 90 includes a signal processing circuit 91, a processor 92, and a memory 93.

The signal processing circuit 91 is a circuit for processing a signal under the control of the processor 92. The signal processing circuit 91 may include a communication circuit that receives a signal from a transmission apparatus.

The processor 92 is connected to the memory 93, and reads and executes a computer program from the memory 93 to execute the processing in the system described in the above example embodiments. As an example of the processor 92, one of a central processing unit (CPU), a micro processing unit (MPU), a field-programmable gate array (FPGA), a digital signal processor (DSP), or an application specific integrated circuit (ASIC) may be used, or a plurality of processors may be used in combination.

The memory 93 includes a volatile memory, a nonvolatile memory, or a combination thereof. The number of memories 93 is not limited to one, and a plurality of memories 93 may be provided. The volatile memory may be, for example, a random access memory (RAM) such as a dynamic random access memory (DRAM) or a static random access memory (SRAM). The nonvolatile memory may be, for example, a read-only memory (ROM) such as a programmable read-only memory (PROM) or an erasable programmable read-only memory (EPROM), a flash memory, or a solid-state drive (SSD).

The memory 93 is used to store one or more instructions. Here, one or more instructions are stored in the memory 93 as a program. The processor 92 can execute the processing described in the above example embodiments by reading and executing these programs from the memory 93.

Note that the memory 93 may include a memory built in the processor 92 in addition to a memory provided outside the processor 92. The memory 93 may include a storage disposed away from a processor implementing the processor 92. In this case, the processor 92 can access the memory 93 via an input/output (I/O) interface.

As described above, one or more processors included in each apparatus of the above example embodiments execute one or more programs including a group of instructions for causing a computer to execute an algorithm described with reference to the drawings. By executing the program, the information processing described in each example embodiment can be implemented.

The program described above includes a group of commands or software codes for causing a computer to perform one or more functions described in the example embodiments if the program is read by the computer. The program may be stored in a non-transitory computer-readable medium or a tangible storage medium. As an example and not by way of limitation, a computer-readable medium or tangible storage medium includes a random access memory (RAM), a read-only memory (ROM), a flash memory, a solid-state drive (SSD) or other memory technology, a compact disc read-only memory (CD-ROM), a digital versatile disc (DVD), a Blu-ray (registered trademark) disk or other optical disk storage, a magnetic cassette, a magnetic tape, a magnetic disk storage, or other magnetic storage devices. The program may be transmitted on a transitory computer-readable medium or a communications medium. By way of example, and not limitation, transitory computer-readable or communication media include electrical, optical, acoustic, or other forms of propagated signals. The transitory computer-readable media or communication media can supply the programs to the computer via a wired communication path such as an electric wire and an optical fiber or a wireless communication path.

Some or all of the above-described example embodiments may be described as in the following Supplementary Notes, but are not limited to the following Supplementary Notes.

### (Supplementary Note 1)

A route selection apparatus including
calculation means for calculating, for each of a plurality of signal paths connected to a transmission apparatus, distortion generated in a transmission signal output from the transmission apparatus by using information regarding distortion in the signal path, and
selection means for selecting one signal path from the plurality of signal paths based on the distortion calculated by the calculation means.

### (Supplementary Note 2)

The route selection apparatus according to Supplementary Note 1, in which the selection means selects a signal path that minimizes the distortion generated in the transmission signal among the plurality of signal paths.

### (Supplementary Note 3)

The route selection apparatus according to Supplementary Note 2, further including control means for causing the transmission apparatus to execute processing of compensating for the distortion of the signal path selected by the selection means.

### (Supplementary Note 4)

The route selection apparatus according to Supplementary Note 3, in which the control means causes the transmission apparatus to execute the processing if an index indicating the distortion in the signal path selected by the selection means is equal to or greater than a predetermined threshold.

### (Supplementary Note 5)

The route selection apparatus according to Supplementary Note 3 or 4, in which the control means causes the transmission apparatus to impart an inverse characteristic of a wavelength converter on a signal path that minimizes the distortion to the transmission signal to execute the processing.

### (Supplementary Note 6)

The route selection apparatus according to Supplementary Note 1, in which
the calculation means calculates, for each of the plurality of signal paths, distortion of the signal path generated in a case where the transmission apparatus executes processing of compensating for the distortion of the signal path, and
the selection means selects a signal path in which the distortion is minimized in a case where the processing is executed.

### (Supplementary Note 7)

The route selection apparatus according to Supplementary Note 6, in which
if an index indicating the distortion is equal to or greater than a predetermined threshold in a signal path in which distortion generated in the transmission signal is minimized among the plurality of signal paths, the calculation means calculates, for each of the plurality of signal paths, distortion of the signal path generated in a case where the processing is executed, and
the selection means selects a signal path in which the distortion is minimized in a case where the processing is executed.

### (Supplementary Note 8)

The route selection apparatus according to any one of Supplementary Notes 1 to 7, in which the calculation means calculates distortion generated in the transmission signal based on distortion derived from a transmission path and distortion derived from wavelength conversion for each of the plurality of signal paths.

### (Supplementary Note 9)

A route selection method executed by a computer, the method including
calculating, for each of a plurality of signal paths connected to a transmission apparatus, distortion generated in a transmission signal output from the transmission apparatus by using information regarding distortion in the signal path, and
selecting one signal path from the plurality of signal paths based on the calculated distortion.

### (Supplementary Note 10)

A program for causing a computer to execute
calculating, for each of a plurality of signal paths connected to a transmission apparatus, distortion generated in a transmission signal output from the transmission apparatus by using information regarding distortion in the signal path, and
selecting one signal path from the plurality of signal paths based on the calculated distortion.

Some or all of the elements (e.g., configurations and functions) described in Supplementary Notes 2 to 8 depending from Supplementary Note 1 may depend from Supplementary Notes 9 to 10 as well with depending relationships similar to those of Supplementary Notes 2 to 8. Some or all of the elements described in any Supplementary Note may be applied to various types of hardware, software, recording means for recording software, systems, and methods.

While the present disclosure has been particularly shown and described with reference to example embodiments thereof, the present disclosure is not limited to these example embodiments. It will be understood by those of ordinary skill in the art that various changes in form and details may be made therein without departing from the sprit and scope of the present disclosure as defined by the claims. And each embodiment can be appropriately combined with at least one of embodiments.

What is claimed is:

1. A route selection apparatus comprising
one or more memories configured to store an instruction, and
one or more processors configured to execute the instruction,
wherein the one or more processors execute the instruction to
calculate, for each of a plurality of signal paths connected to a transmission apparatus, distortion generated in a transmission signal output from the transmission apparatus by using information regarding distortion in the signal path, and
select one signal path from the plurality of signal paths based on the calculated distortion.

2. The route selection apparatus according to claim 1, wherein the one or more processors execute the instruction to
select a signal path that minimizes the distortion generated in the transmission signal among the plurality of signal paths.

3. The route selection apparatus according to claim 2, wherein the one or more processors execute the instruction to
cause the transmission apparatus to execute processing of compensating for the distortion of the selected signal path.

4. The route selection apparatus according to claim 3, wherein the one or more processors execute the instruction to
cause the transmission apparatus to execute the processing if an index indicating the distortion in the selected signal path is equal to or greater than a predetermined threshold.

5. The route selection apparatus according to claim 3, wherein the one or more processors execute the instruction to
cause the transmission apparatus to impart an inverse characteristic of a wavelength converter on a signal path that minimizes the distortion to the transmission signal to execute the processing.

6. The route selection apparatus according to claim 1, wherein the one or more processors execute the instruction to
calculate, for each of the plurality of signal paths, distortion of the signal path generated in a case where the transmission apparatus executes processing of compensating for the distortion of the signal path, and
select a signal path in which the distortion is minimized in a case where the processing is executed.

7. The route selection apparatus according to claim 6, wherein the one or more processors execute the instruction to
if an index indicating the distortion is equal to or greater than a predetermined threshold in a signal path in which distortion generated in the transmission signal is minimized among the plurality of signal paths, calculate, for each of the plurality of signal paths, distortion of the signal path generated in a case where the processing is executed, and
select a signal path in which the distortion is minimized in a case where the processing is executed.

8. The route selection apparatus according to claim 1, wherein the one or more processors execute the instruction to
calculate distortion generated in the transmission signal based on distortion derived from a transmission path and distortion derived from wavelength conversion for each of the plurality of signal paths.

9. A route selection method executed by a computer, the method comprising
calculating, for each of a plurality of signal paths connected to a transmission apparatus, distortion generated in a transmission signal output from the transmission apparatus by using information regarding distortion in the signal path, and
selecting one signal path from the plurality of signal paths based on the calculated distortion.

10. A non-transitory computer-readable medium storing a program for causing a computer to execute the steps of
calculating, for each of a plurality of signal paths connected to a transmission apparatus, distortion generated in a transmission signal output from the transmission apparatus by using information regarding distortion in the signal path, and
selecting one signal path from the plurality of signal paths based on the calculated distortion.
